(19) United States
(12) Patent Application Publication
(10) Pub. No.: US 2004/0215692 A1
(43) Pub. Date: Oct. 28, 2004

(54) Advertising for wireless content providers

(76) Inventors: Venugopal Vasudevan, Palatine, IL (US); Tzvetan T. Horozov, Hoffman Estates, IL (US)

Correspondence Address: MOTOROLA, INC., 1303 EAST ALGONQUIN ROAD, IL01/3RD, SCHAUMBURG, IL, 60196

(21) Appl. No.: 10/395,313

(22) Filed: Mar. 24, 2003

(51) Int. Cl. G06F 15/16

(52) U.S. Cl. 709/201

(57) ABSTRACT

A method and apparatus for advertising is provided herein. Location-based content (advertisements) are provided to users of a communication system. A correlation between a user's displayed advertisements and the user's subsequent location is made is a basis for charging fees to the advertiser.

### FIELD OF THE INVENTION

The present invention relates generally to advertising and in particular, to a method and apparatus for advertising for wireless content providers.

### BACKGROUND OF THE INVENTION

Communication systems having location-based applications that display surrounding points of interest are known in the art. Such communication systems generally determine a user's location and provide advertisements to the user for places near the user's location. One method for obtaining revenue for such advertisements is by charging a business based on a number of times a business' advertisement was displayed. While such a business model does provide a method for an advertiser to charge for advertising, a drawback with such advertising is that there is no proof that the user followed-through on the advertisement. For example, if the advertisement being viewed by a user is a concert, hotel, or a museum, there is no proof that the user actually went to the concert, stayed at the hotel, or went to the museum. Such proof would make advertising more effective, and could generate substantially more money for content providers. Therefore, a need exists for a method and apparatus for advertising that determines if a user actually acted upon a displayed advertisement.

### BRIEF DESCRIPTION OF THE DRAWINGS

FIG. 1 is a block diagram of a communication system in accordance with the preferred embodiment of the present invention.

FIG. 2 is a block diagram of a base station and a remote unit in accordance with the preferred embodiment of the present invention.

FIG. 3 is a block diagram of a base station and remote unit in accordance with an alternate embodiment of the present invention.

FIG. 4 is a flow chart showing operation of the base site of FIG. 2 in accordance with the preferred embodiment of the present invention.

FIG. 5 is a flow chart showing operation of the remote unit of FIG. 2 in accordance with the alternate embodiment of the present invention.

### DETAILED DESCRIPTION OF THE DRAWINGS

To address the above-mentioned need, a method and apparatus for advertising is provided herein. In accordance with the preferred embodiment of the present invention, location-based content (such as advertisements) are provided to users of a communication system. A correlation between a user's displayed advertisements and the user's subsequent location is made, and is a basis for charging fees to the advertiser.

Because a determination can be made whether or not a viewer of an advertisement actually followed-through on the advertisement (i.e., visited the location), content providers are able to specifically charge advertisers a premium when their advertisement generates business. Additionally, advertisers can be provided specific information on the amount of customers actually following up on a particular advertisement. This will allow advertisers to determine the effectiveness of any advertisement.

The present invention encompasses a method for advertising. The method comprises the steps of determining a location of a remote unit and transmitting an advertisement message to the remote unit based on the location. A location of an advertiser of the advertisement message is determined and the remote unit is tracked to determine a subsequent location of the remote unit. The subsequent location of the remote unit is correlated to the location of the advertiser.

The present invention additionally encompasses a method for advertising. The method comprises the steps of transmitting an advertisement message to a remote unit, determining a location of an advertiser of the advertisement message, and tracking the remote unit to determine a subsequent location of the remote unit. The subsequent location of the remote unit is correlated to the location of the advertiser.

The present invention additionally encompasses an apparatus comprising a Point-Of-Interest (POI) calculator for determining a location of a remote unit and transmitting an advertisement message to the remote unit based on the location, a POI-to-location converter for determining a location of an advertiser of the advertisement message, a visit tracker for tracking the remote unit to determine a subsequent location of the remote unit, and a database storing correlations that exist in the subsequent location of the remote unit and the location of the advertiser.

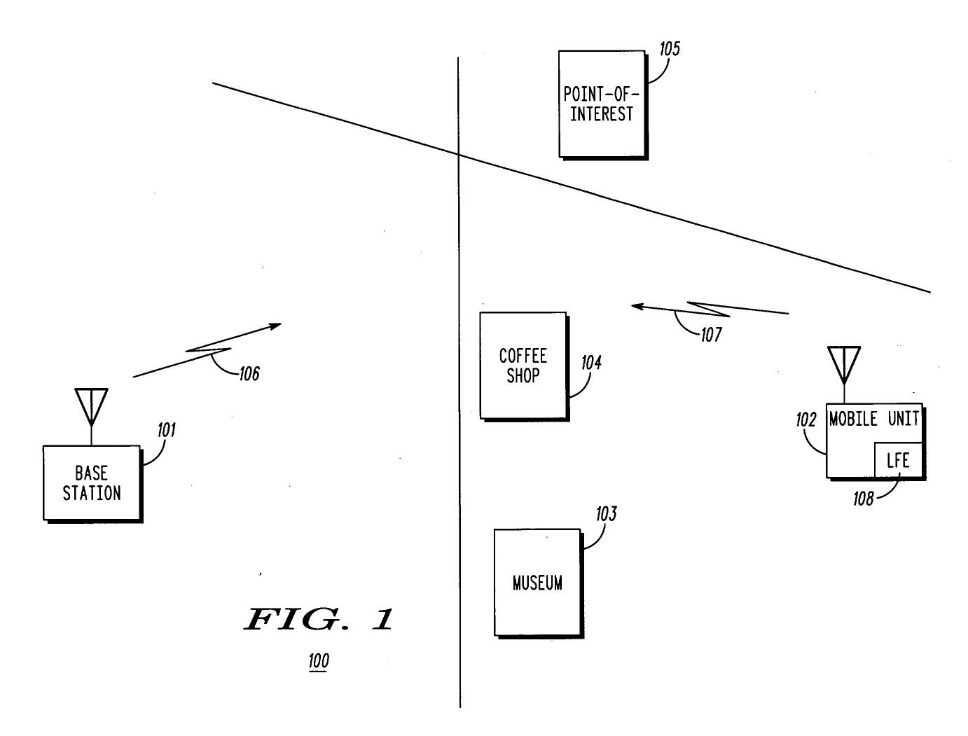

Turning now to the drawings, wherein like numerals designate like components, FIG. 1 is a block diagram of communication system 100 in accordance with the preferred embodiment of the present invention. In the preferred embodiment of the present invention, communication system 100 is preferably a cellular communication system that may incorporate any number of communication system protocols. For example, communication system 100 may comprise a Code Division Multiple Access (CDMA) system as described in Cellular System Remote unit-Base Station Compatibility Standard of the Electronic Industry Association/Telecommunications Industry Association Interim Standard 95 (TIA/EIA/IS-95A), or may comprise a communication system as described in any of the next-generation communication system protocols. Regardless of the protocol utilized by communication system 100, communication system 100, at a minimum includes base station 101 and mobile, or remote unit 102. As shown, remote unit 102 is communicating with base station 101 via uplink communication signals 107 and base station 101 is communicating with remote unit 102 via downlink communication signals 106. For simplicity, only one base station 101 and remote unit 102 are shown in FIG. 1, however, one of ordinary skill in the art will recognize that communication system 100 may, and typically does comprise multiple base stations in communication with multiple remote units.

In the preferred embodiment of the present invention communication system 100 is equipped with location-finding equipment (LFE) 108 utilized to locate and track a location of remote unit 102. Although LFE 108 is shown existing internal to remote unit 102, LFE 108 may reside internal to, or external to any network element (e.g., base station 101) of communication system 100. In the preferred embodiment of the present invention LFE 108 comprises a Global Positioning System (GPS) located within remote unit 102 that transmits a latitude and longitude value to base station 101. However, in alternate embodiments of the present invention LFE 108 may utilize a number of radio location techniques such as, but not limited to a Time of Arrival (TOA) technique, a Time Difference of Arrival (TDOA) technique, and/or an Angle of Arrival (AOA) technique.

In the preferred embodiment of the present invention remote unit 102 is equipped with an application that displays surrounding points of interest. This is accomplished by LFE 108 determining the remote unit's location and transmitting the location to base station 101. Base station 101 then determines the proximity of remote unit 108 to local points of interest (e.g., museum 103, coffee shop 104, and point of interest 105). Base station 101 then provides advertisements to remote unit 102 for places near the remote unit's location.

As discussed above, while providing advertisements for local businesses can generate revenue for the content provider, a drawback with such advertising techniques is that there is no proof that the viewer of the advertisement followed-through on the advertisement. For example, if the advertisement being viewed by a user is an advertisement for coffee shop 104, prior-art systems failed to determine if the user actually went to coffee shop 104. Such a determination would make advertising more effective, and could generate substantially more revenue for content providers, since the content provider can now charge for advertisements that actually generated traffic.

In order to solve the above-mentioned problem, a correlation between a user's displayed advertisements and the user's subsequent location is made a basis for charging fees to the advertiser. More particularly, base station 101 computes the GPS location of a POI viewed by remote unit 102 (some points of interest such as franchises (e.g. McDonalds) can map to more than one location). A user visit to the location can be determined by the fact that the remote unit's location remains-unchanged for some period of time. Base station 101 tracks the remote unit's movements, and then reverse correlates location information with the associated POI.

Because a determination can be made whether or not a viewer of an advertisement actually followed-through on the advertisement (i.e., visited the location), content providers are able to specifically charge advertisers a premium when their advertisement generates business. Additionally, advertisers can be provided specific information on the amount of customers actually following up on a particular advertisement. This will allow advertisers to determine the effectiveness of any advertisement.

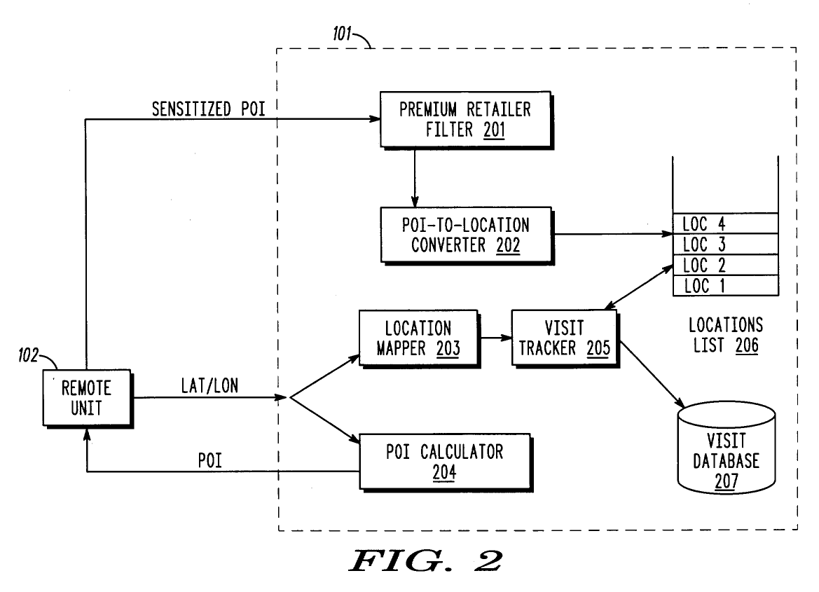

FIG. 2 is a block diagram of base station 101 and remote unit 102 in accordance with the preferred embodiment of the present invention. As shown, base station 101 comprises premium retailer filter 201, POI-to-location converter 202, location mapper 203, POI calculator 204, visit tracker 205, sensitized locations list 206, and visit database 207. In the preferred embodiment of the present invention location information is transmitted from remote unit 102 to base station 101. POI calculator 204 receives the remote unit's location, calculates POIs local to the remote unit, and broadcasts the POIs to remote unit 102. As discussed above, the POIs broadcast to remote unit 102 may comprise paid advertisements from local retailers, and/or local points of interest that are not advertisements (e.g., museums, buildings, beaches, . . . , etc.).

In the preferred embodiment of the present invention when any content is viewed by the user (remote unit 102), this fact is transmitted back to base station 101 and becomes a “sensitized” POI. In other words, in the preferred embodiment of the present invention base station 101 is informed, and from this information determines those POIs/advertisements that are actually viewed by remote unit 102.

Premium retailer filter 201 accesses the sensitized POI and determines if an advertiser has paid for the advertisement to be broadcast to remote unit 102. If so, the POI is forwarded to the POI-to-location converter 202 where a location of the POI is determined. POI-to-location converter 202 is simply a database comprising locations (e.g., latitude/longitude) for all paid advertisers.

Once the location of an advertiser of a viewed advertisement is determined, the location is stored in locations list 206. Thus, in the preferred embodiment of the present invention locations list 206 comprises a list of the locations of establishments for all viewed advertisements. While the above-described steps take place, location mapper 203 is continuously receiving location information from remote unit 102 and determines a physical location for remote unit 102. For example, location mapper 203 is continuously receiving latitude/longitude information from remote unit 102 and determining those establishments (museums, restaurants, public buildings, . . . , etc.) visited by remote unit 102. A list of places visited is passed to visit tracker 205, where the list is compared to locations list 206. If it is determined that remote unit 102 visited an establishment on locations list 206, then this fact is stored in database 207.

As discussed above, because a determination can be made whether or not a viewer of an advertisement actually followed-through on the advertisement (i.e., visited the location), content providers are able to specifically charge advertisers a premium when their advertisement generates business. Additionally, advertisers can be provided specific information on the amount of customers actually following up on a particular advertisement. This will allow advertisers to determine the effectiveness of any advertisement.

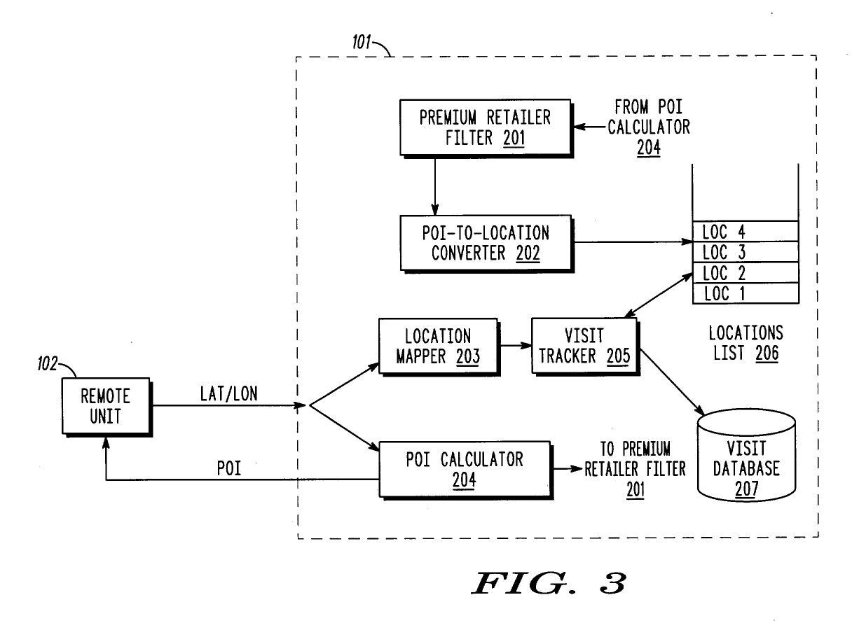

FIG. 3 is a block diagram of a base station and remote unit in accordance with an alternate embodiment of the present invention. In the alternate embodiment of the present invention actual information on whether or not an advertisement was viewed by remote unit 102 is not fed back to base station 101. In this situation, POI calculator 204 sends a list of all content transmitted to remote unit 102 to premium retailer filter 201. Thus, premium retailer filter 201 receives a list of all content that was transmitted to remote unit 102. Premium retailer filter 201 accesses the list and determines if an advertiser has paid for the advertisement (content) to be broadcast to remote unit 102. If so, the POI is forwarded to the POI-to-location converter 202 where a location of the POI is determined and the logic flow takes place as described above with reference to FIG. 2.

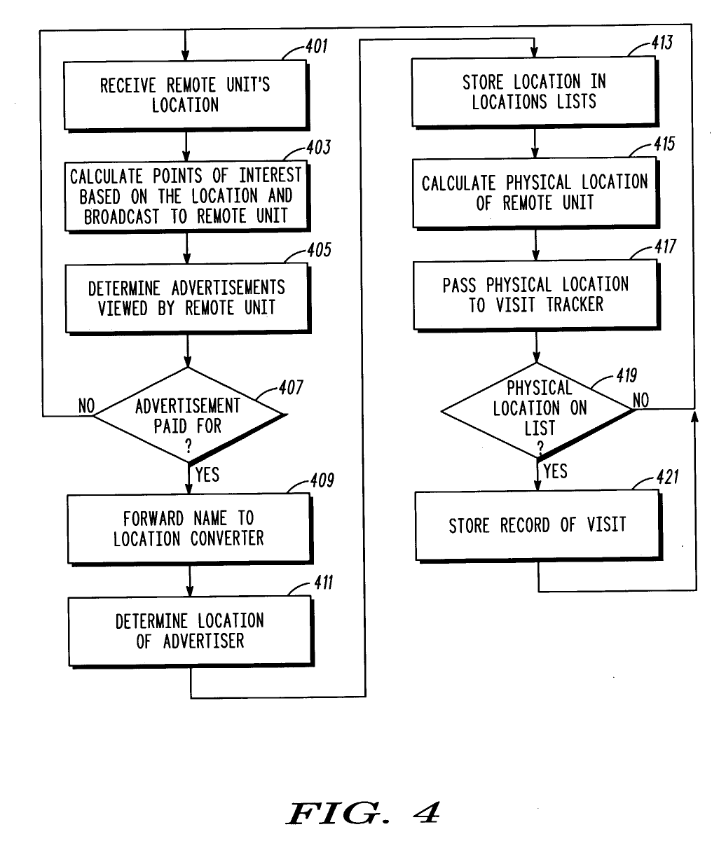

FIG. 4 is a flow chart showing operation of the base site of FIG. 2 in accordance with the preferred embodiment of the present invention. The logic flow begins at step 401 where a remote unit's location is received by base station 101. At step 403 POI calculator 204 calculates points of interest based on the location of remote unit 101 and broadcasts the POIs to remote unit 101. At step 405 a list of those advertisements that were actually viewed by remote unit 101 is determined. This is accomplished via a sensitized POI feedback from remote unit 102. In particular, this information could be transmitted over an IP (Internet Protocol) stack layered over any cellular bearer architecture (e.g. GSM, CDMA) or could use a signaling channel already available in these architectures. In the preferred embodiment, the former technique is used.

At step 407 it is determined if a retailer paid for any of the advertisements. If, at step 407 it is determined that a retailer actually paid for an advertisement viewed by remote unit 102, the logic flow continues to step 409, otherwise the logic flow returns to step 401. At step 409 the name of the retailer who paid for the advertisement is forwarded to POI-to-location converter 202 and a location for the retailer is determined (step 411). The location is stored in locations list 206 (step 413).

At step 415 location mapper 203 receives latitude and longitude information from remote unit 102 and calculates a physical location for remote unit 102. The physical location is passed to visit tracker 205 (step 417) where visit tracker 205 determines if the physical location is located on locations list 206 (step 419). If, at step 419, it is determined that the physical location of remote unit 102 is on locations list 206, the logic flow continues to step 421 where a record of the visit is stored in database 207. If, however, it is determined that the physical location is not on locations list 206, then the logic flow returns to step 401.

It should be noted that to better assure remote unit 102 is actually visiting a POI, visit tracker 205 may require remote unit 102 to be physically located at a particular establishment for a predetermined period of time prior to actually storing a record of the visit in database 207. For example, if remote unit 102 receives an advertisement for coffee shop 104, and simply passes coffee shop 104 on the way to museum 103, visit tracker 205 will not record a visit in database 207 since the location of remote unit 102 was not at coffee shop 104 for a predetermined period of time. If, however, remote unit 102 stops by coffee shop 104 on the way to museum 103, visit tracker 205 will record the fact that the location of remote unit 102 was within coffee shop 104 for greater than the predetermined time period, and the visit will be recorded within database 207.

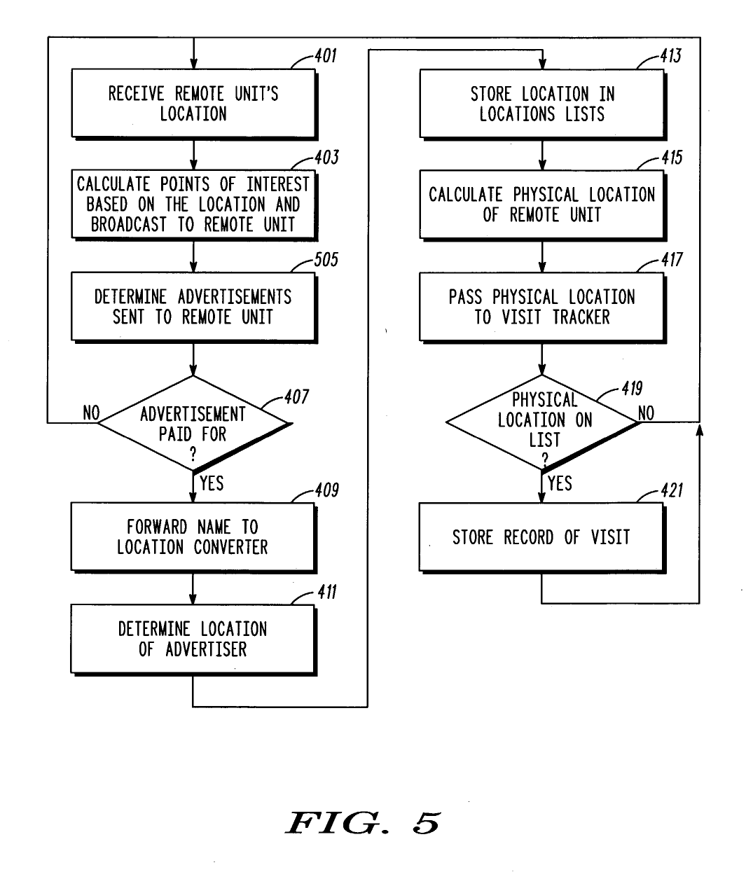

FIG. 5 is a flow chart showing operation of the remote unit of FIG. 2 in accordance with the preferred embodiment of the present invention. As discussed above, in the alternate embodiment of the present invention actual information on whether or not an advertisement was viewed by remote unit 102 is not fed back to base station 101. In the alternate embodiment, POI calculator 204 sends a list of all content (advertisements) transmitted to remote unit 102 to premium retailer filter 201. Thus, in the alternate embodiment, if an advertisement was sent to remote unit 102, and then remote unit 102 visits the particular establishment, the visit will be recorded in database 207. The logic flow of FIG. 5 is similar to that in FIG. 4 except for step 405. In the alternate embodiment, step 405 is replaced by step 505. At step 405 a list of those advertisements that were actually sent to remote unit is transmitted from POI calculator 204 to premium retailer filter 201. The logic flow continues as described above with reference to FIG. 4.

While the invention has been particularly shown and described with reference to a particular embodiment, it will be understood by those skilled in the art that various changes in form and details may be made therein without departing from the spirit and scope of the invention. For example, when dealing with advertisers that are franchises (e.g. Nordstroms) or corporations with multiple brands (e.g. Limited Inc has Abercrombie and Fitch and Express) database tracking may correlate a POI viewed by the remote unit 102 with visits to not only that POI, but other POIs with close corporate relationships to the viewed POI. Additionally, a time-limited and POI-specific promotion can be present to the user in response to the viewed POI. The user can be tracked to determine if the user does indeed visit this POI using the correlation scheme listed above. Finally, although the functionality of tracking/billing is shown existing within a base station of a communication system, one of ordinary skill in the art will recognize that the functionality described above may be located within any network element, or distributed among several network elements. It is intended that such changes come within the scope of the following claims.

1. A method for advertising, the method comprising the steps of:
determining a location of a remote unit;
transmitting an advertisement message to the remote unit based on the location;
determining a location of an advertiser of the advertisement message;
tracking the remote unit to determine a subsequent location of the remote unit; and
correlating the subsequent location of the remote unit to the location of the advertiser.

2. The method of claim 1 further comprising the step of:
charging the advertiser a fee when the location of the remote unit correlates to the location of the advertiser.

3. The method of claim 1 wherein the step of determining the location of the remote unit comprises the step of determining a geographic location of the remote unit.

4. The method of claim 3 wherein the step of determining the geographic location comprises the step of determining a latitude and a longitude.

5. The method of claim 1 wherein the step of transmitting the advertisement message to the remote unit comprises the step of transmitting an over-the-air message to the remote unit comprising the advertisement message.

6. The method of claim 1 wherein the step of correlating the subsequent location of the remote unit comprises the step of determining if the remote unit existed at the location of the advertiser for a predetermined time period.

7. The method of claim 1 further comprising the steps of:
determining if a user viewed the advertisement message; and
charging the advertiser a fee when the location of the remote unit correlates to the location of the advertiser, and the user actually viewed the advertisement message.

8. A method for advertising, the method comprising the steps of:
transmitting an advertisement message to a remote unit;
determining a location of an advertiser of the advertisement message;
tracking the remote unit to determine a subsequent location of the remote unit; and
correlating the subsequent location of the remote unit to the location of the advertiser.

9. The method of claim 7 further comprising the step of:
charging the advertiser a fee when the location of the remote unit correlates to the location of the advertiser.

10. The method of claim 7 wherein the step of tracking the remote unit comprises the step of determining a geographic location of the remote unit.

11. The method of claim 9 wherein the step of determining the geographic location comprises the step of determining a latitude and a longitude.

12. The method of claim 7 wherein the step of transmitting the advertisement message to the remote unit comprises the step of transmitting an over-the-air message to the remote unit comprising the advertisement message.

13. The method of claim 7 wherein the step of correlating the subsequent location of the remote unit comprises the step of determining if the remote unit existed at the location of the advertiser for a predetermined time period.

14. The method of claim 8 further comprising the steps of:
determining if a user viewed the advertisement message; and
charging the advertiser a fee when the location of the remote unit correlates to the location of the advertiser, and the user actually viewed the advertisement message.

15. An apparatus comprising:
a POI calculator for determining a location of a remote unit and transmitting an advertisement message to the remote unit based on the location;
a POI-to-location converter for determining a location of an advertiser of the advertisement message;
a visit tracker for tracking the remote unit to determine a subsequent location of the remote unit; and
a database storing correlations that exist in the subsequent location of the remote unit and the location of the advertiser.
